(19) United States
(12) Patent Application Publication
(10) Pub. No.: US 2007/0261927 A1
(43) Pub. Date: Nov. 15, 2007

(54) Brake lining carrier plate for a disc brake

(75) Inventors: Johann Iraschko, Schweitenkirchen (DE); Manfred Schoenauer, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme Fuer Nutzfahrzeuge GmbH, Muenchen (DE)

(21) Appl. No.: 11/797,489

(22) Filed: May 3, 2007

Related U.S. Application Data
(63) Continuation of application No. PCT/EP05/11733, filed on Nov. 3, 2005.

(30) Foreign Application Priority Data
Nov. 3, 2004 (DE) 10 2004 053 026.2

(51) Int. Cl. F16D 65/40

(52) U.S. Cl. 188/73.38

(57) ABSTRACT

A brake lining support plate arrangeable in a lining housing of a disc brake for a land vehicle includes at least one tolerance compensating spring for compensating tolerance between the lining support plate and the plate housing. The tolerance compensating spring(s) are embodied in the form of leaf- or leg-springs, wherein the leaf spring or the first leg of the leg spring is used for compensating the tolerances in a radial direction and the other leaf spring or the second leg of the leg spring is used for compensating tolerances in a circumferential direction.

### CROSS-REFERENCE TO RELATED APPLICATIONS

This application is a continuation of PCT International Application No. PCT/EP2005/011733, filed on Nov. 3, 2005, which claims priority under 35 U.S.C. § 119 to German Application No. 10 2004 053 026.2, filed Nov. 3, 2004, the entire disclosures of which are expressly incorporated by reference herein.

### BACKGROUND AND SUMMARY OF THE INVENTION

The present invention relates to a brake lining carrier plate having at least one tolerance compensating spring and, more particularly, to a brake lining carrier plate, which is insertable into a lining slot of a vehicle's disc brake and has at least one tolerance compensating spring for compensating tolerances between the lining carrier plate and the lining slot.

Lining carrier plates are generically known, for example, from U.S. Pat. No. 5,941,348 or JP-A-9229112.

In disc brakes, which can be used both in passenger vehicles and also in utility or commercial vehicles, use is made of lining carrier plates which are insertable into lining slots, which support them, and have brake linings arranged thereon. The brake linings are pressed against the brake disc by application devices for the purpose of braking the brake disc, and hence the vehicle.

When traveling over uneven underlying surfaces, high acceleration forces occur, which also act on the lining carrier plates. A play is required, in principle, between the lining carrier plates on the one hand and the lining slots on the other hand. The requirement for this play is generated on the one hand by the required compensation of production tolerances and on the other hand by the requirement for compensating different thermal length variations of the lining carrier plate and the brake lining, as well as the lining slot, during operation. The presence of the required play and the acceleration forces which act on the lining carrier plate when traveling over uneven underlying surfaces result in a considerable audible rattling noise, which is tolerated to an ever-reduced degree on account of the low interior noise level which has been achieved in vehicle manufacturing in the meantime.

A further factor for the resulting rattling noises is that, when the disc brake is actuated, the brake linings come into contact with the runout-side support face in the lining slot, and when the brake is released, fall back against the opposite support face. This generates a considerable audible metallic noise, which many customers negatively perceive as being very disturbing, primarily during low-speed maneuvering operation.

For the above reasons, use is already made of tolerance compensating springs in order to maintain the mobility of the lining carrier plate and of the brake lining, but in addition to largely eliminate the metallic hard impacting of the lining carrier plate against corresponding support faces.

The present invention improves upon the known lining carrier plates and is distinguished by particularly effective noise damping with, at the same time, an extremely simple configuration of the tolerance compensating spring or of the tolerance compensating springs without thereby significantly increasing the residual wear torques of the linings.

According to the present invention, the tolerance compensating spring or the tolerance compensating springs is or are embodied as leaf springs or leg springs, with, in each case, one leaf spring or a first leg of a leg spring being provided for compensating the tolerances in the radial direction, and in each case, the other leaf spring or the second leg of a leg spring being provided for compensating the tolerances in the tangential direction.

A lining carrier plate according to the invention provides a simple configuration of the tolerance compensating springs as well as highly effective noise damping for all movement directions of the lining carrier plate, since correspondingly simply configured tolerance compensating springs act both in the radial direction and also in the tangential direction.

According to one refinement of the invention, it is provided that the leaf springs or leg springs are arranged, in each case, in the transition region between the concave lower edge and the head-side end edges of the lining carrier plate.

If leaf springs are provided for the tolerance compensation, one advantageous embodiment of the invention provides that the leaf springs for the radial tolerance compensation are identical in construction to the leaf springs for the tangential tolerance compensation.

If leg springs are used for the tolerance compensation, it is provided according to a further exemplary embodiment of the invention that the leg springs are formed so as to be mirror-symmetrical about a central axis.

The latter measures permit the use of tolerance compensating springs of identical design in all fields of use of the lining carrier plate.

Further features of the invention are described and claimed herein.

Other objects, advantages and novel features of the present invention will become apparent from the following detailed description of the invention when considered in conjunction with the accompanying drawings.

### BRIEF DESCRIPTION OF THE DRAWINGS

FIGS. 1a to 1e show different views of a tolerance compensating spring for a lining carrier plate according to the invention;

FIG. 2 shows a partial view of a lining carrier plate according to the invention having a mounted tolerance compensating spring as per FIGS. 1a to 1e;

FIG. 3 shows a view of the lining carrier plate in the direction of the arrow III in FIG. 2;

FIG. 4 shows a view, corresponding to FIG. 2, of a lining carrier plate according to a further exemplary embodiment of the invention; and

FIG. 5 shows a view in the direction of the arrow V in FIG. 4.

### DETAILED DESCRIPTION OF THE DRAWINGS

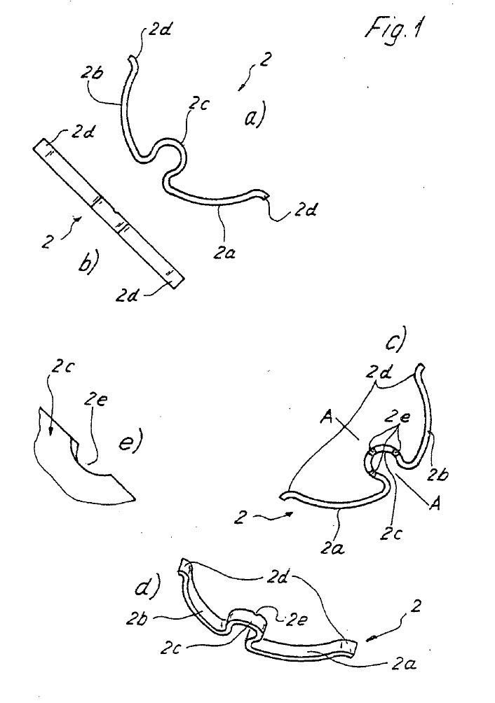

In the exemplary embodiment of the invention shown in FIGS. 1 to 3, the reference symbol 1 denotes a brake lining carrier plate, which is insertable into a lining slot of a vehicle disc brake, and has a tolerance compensating spring 2 capable of compensating tolerances between the lining slot (not illustrated) and the lining carrier plate 1, without restricting the mobility of the lining carrier plate 1 within the lining slot.

The tolerance compensating spring 2, which is shown in great detail in various views in FIGS. 1a to 1e, has the shape of, and is embodied, as a leg spring, which is formed so as to be mirror-symmetrical about a central axis A-A (see in particular FIG. 1c).

The leg spring 2 has a first leg 2a and a second leg 2b which, in their end regions which face one another, merge into an arcuately domed central fastening part 2c.

At their free ends, the two legs 2a and 2b are equipped with supports 2d, which are bent counter to the curvature of the two legs 2a and 2b.

As shown in particular by FIG. 3, the tolerance compensating spring 2 is inserted by way of its fastening part 2c within an identically-shaped cutout 1a of the lining carrier plate 1, and is fixed relative to the lining carrier plate 1, for example, by means of calking. The respective supports 2d of the two legs 2a and 2b are supported in this mounted state against preferably rectilinearly-running support flanks 1b of the lining carrier plate 1.

As can be clearly seen from FIG. 2, in the mounted state of the tolerance compensating spring 2, a first leg 2a is situated approximately in the region of a concave lower edge 1c, and the other leg 2b is situated in the region of a head-side end edge 1d of the lining carrier plate 1.

As a result of the configuration and arrangement of the tolerance compensating spring 2, the tolerance compensating spring 2 is capable of compensating both radial tolerances between a lining carrier plate 1 and a lining slot, and tolerances in the tangential direction.

FIG. 2 illustrates only one half of the lining carrier plate 1; a tolerance compensating spring as described above is preferably fastened in the corresponding position in the left-hand half (not illustrated) of the lining carrier plate.

On account of the mirror-symmetrical configuration of the tolerance compensating spring 2, the tolerance compensating springs 2 arranged at the left-hand side and at the right-hand side can preferably be identical in construction to one another.

FIG. 1e shows that the tolerance compensating spring 2 may be provided in the region of its fastening part 2c with indentations 2e which serve as calking marks and facilitate the calking of the fastening part 2c relative to the lining carrier plate 1.

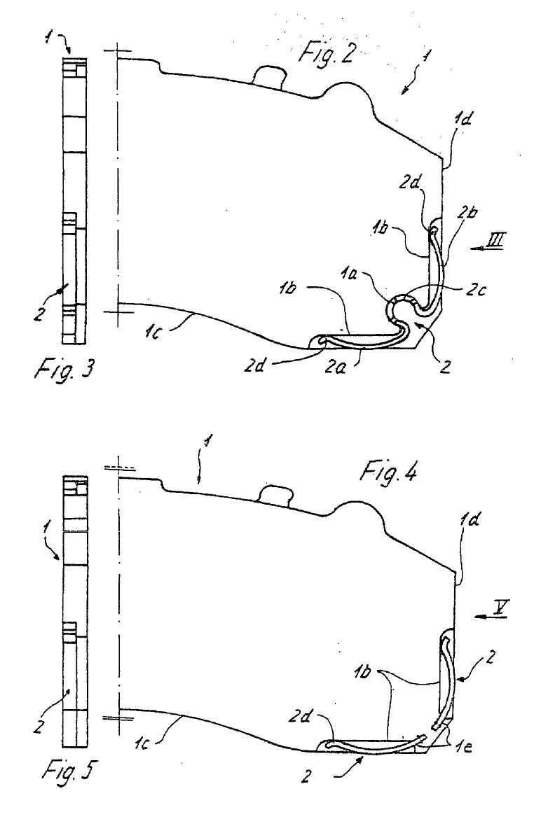

In one exemplary embodiment of the invention as per FIGS. 4 and 5, tolerance compensating springs 2 in the form of leaf springs, which are identical in construction, are provided in the transition region between the concave lower edge 1c and the adjoining head-side end edges 1d. The leaf springs are, in turn, provided at their regions which face away from one another with curved supports 2d for supporting on support faces 1b of the lining carrier plate 1. Those ends of the leaf springs which face one another are, for the purpose of connecting to the lining carrier plate 1, inserted into slots 1e of the lining carrier plate 1 and are again fixed there preferably by calking, or else by welding.

Tolerance compensating springs 2 in the form of the leaf springs illustrated in FIG. 3 can also be arranged on the left-hand side (not illustrated) of the lining carrier plate, with the left-hand-side leaf springs also being identical in construction to the leaf springs on the right-hand side (illustrated) of the lining carrier plate 1.

Both exemplary embodiments achieve the advantage that, despite the use of simply configured springs, which may be used both at the left-hand side and at the right-hand side, tolerance compensation is provided between the lining carrier plate 1 and a lining slot (not illustrated) in two directions.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A disc brake component insertable into a lining slot of a disc brake, comprising:
a brake lining carrier plate having a concave lower edge and head-side end edges; and
at least one tolerance compensating spring arranged on the brake lining carrier plate for compensating tolerances between the brake lining carrier plate and the lining slot when inserted;
wherein the at least one tolerance compensating spring is one of a leaf spring and a leg spring, one leaf spring or a first leg of a leg spring compensating tolerances in a radial direction and another leaf spring or a second leg of the leg spring compensating tolerances in a tangential direction;
wherein the leaf spring or leg spring is arranged in a transition region between the concave lower edge and a respective head-side end edge of the lining carrier plate; and
wherein the leaf spring for the radial tolerance compensation is identical in construction to the leaf spring for the tangential tolerance compensation, and wherein the leg spring is mirror-symmetrical about a central axis.

2. The disc brake component as claimed in claim 1, wherein two leg springs are used, one leg spring being arranged in each transition region between the concave lower edge and a respective head-side end edge of the lining carrier plate, the two leg springs having an identical construction.

3. The disc brake component as claimed in claim 1, wherein the at least one tolerance compensating spring is fixed relative to the lining carrier plate via one of calking and welding.

4. The disc brake component as claimed in claim 2, wherein the at least one tolerance compensating spring is fixed relative to the lining carrier plate via one of calking and welding.

5. The disc brake component as claimed in claim 1, wherein the leg spring includes a dome-shaped fastening section at a transition region between the two legs of the leg spring, the fastening section engaging into a corresponding cutout in the lining carrier plate.

6. The disc brake component as claimed in claim 2, wherein the leg spring includes a dome-shaped fastening section at a transition region between the two legs of the leg spring, the fastening section engaging into a corresponding cutout in the lining carrier plate.

7. The disc brake component as claimed in claim 1, wherein the leaf spring for the radial tolerance compensation has one end inserted into a slot of the lining carrier plate and the leaf spring for tangential tolerance compensation has one end inserted into another slot of the lining carrier plate, wherein both leaf springs are fastened within the slot to the lining carrier plate via one of calking and welding.

8. The disc brake component as claimed in claim 1, wherein each leg of the leg spring or free ends of the leaf springs include supports that are supported on support flanks of the lining carrier plate.

9. The disc brake component as claimed in claim 2, wherein each leg of the leg spring or free ends of the leaf springs include supports that are supported on support flanks of the lining carrier plate.

10. The disc brake component as claimed in claim 3, wherein each leg of the leg spring or free ends of the leaf springs include supports that are supported on support flanks of the lining carrier plate.

11. The disc brake component as claimed in claim 5, wherein indentations are formed in the fastening section of the leg spring, the indentations serving as calking marks.

12. The disc brake component as claimed in claim 6, wherein indentations are formed in the fastening section of the leg spring, the indentations serving as calking marks.

13. A disc brake component insertable into a lining slot of a disc brake, comprising:
a brake lining carrier plate having a concave lower edge and head-side end edges; and
at least one tolerance compensating spring arranged on the brake lining carrier plate for compensating tolerances between the brake lining carrier plate and the lining slot when inserted;
wherein the at least one tolerance compensating spring comprises leaf springs, one leaf spring compensating tolerances in a radial direction and another leaf spring compensating tolerances in a tangential direction;
wherein the leaf springs are arranged in a transition region between the concave lower edge and a respective head-side end edge of the lining carrier plate; and
wherein the leaf spring for the radial tolerance compensation is identical in construction to the leaf spring for the tangential tolerance compensation.

14. A disc brake component insertable into a lining slot of a disc brake, comprising:
a brake lining carrier plate having a concave lower edge and head-side end edges; and
at least one tolerance compensating spring arranged on the brake lining carrier plate for compensating tolerances between the brake lining carrier plate and the lining slot when inserted;
wherein the at least one tolerance compensating spring comprises a leg spring, a first leg of the leg spring compensating tolerances in a radial direction and a second leg of the leg spring compensating tolerances in a tangential direction;
wherein the leg spring is arranged in a transition region between the concave lower edge and a respective head-side end edge of the lining carrier plate; and
wherein the leg spring is mirror-symmetrical about a central axis.
